(19) United States
(12) Patent Application Publication
(10) Pub. No.: US 2022/0294178 A1
(43) Pub. Date: Sep. 15, 2022

(54) EFFICIENT RAMAN VISIBLE LASER WITH MINIMIZING THE CAVITY LOSSES FOR THE STOKES WAVE

(71) Applicant: National Yang Ming Chiao Tung University, Hsinchu City (TW)

(72) Inventors: Yung-Fu Chen, Hsinchu City (TW); Hsing-Chih Liang, Hsinchu City (TW); Chia-Han Tsou, Hsinchu City (TW)

(73) Assignee: National Yang Ming Chiao Tung University, Hsinchu City (TW)

(21) Appl. No.: 17/464,881

(22) Filed: Sep. 2, 2021

(30) Foreign Application Priority Data
Mar. 11, 2021 (TW) 110108779

(51) Int. Cl. H01S 3/30; H01S 3/02; H01S 3/06; H01S 3/109; H01S 3/16; G02F 1/355; G02F 1/35

(52) U.S. Cl. CPC H01S 3/30; H01S 3/025; H01S 3/0602; H01S 3/109; H01S 3/1611; H01S 3/1671; G02F 1/3551; G02F 1/354; G02F 1/3534

(57) ABSTRACT

The invention discloses a visible laser apparatus including a linear cavity. The linear cavity includes along the first direction: a first optical component, a gain medium, a second optical component, a Raman crystal, a double-harmonic crystal and a third optical component. The first optical component receives an incident pumping light in the first direction. The gain medium receives the pumping light from the first optical component, and generates a first infrared base laser having a first wavelength. The second optical component has a first high transmittance in a first wave band including the first wavelength in the first and the second directions. The Raman crystal receives the first infrared base laser, and generates a second infrared base laser having a second wavelength. The double-harmonic crystal receives the first and the second infrared base lasers, and generates a visible laser light having a third wavelength.

### CROSS-REFERENCE TO RELATED APPLICATION AND CLAIM OF PRIORITY

This application claims the benefit of Taiwan Patent Application No. 110108779, filed on Mar. 11, 2021, at the Taiwan Intellectual Property Office, the disclosures of which are incorporated herein in their entirety by reference.

### FIELD OF THE INVENTION

The present invention is related to a visible laser device, in particular a visible laser apparatus with a linear cavity being able to generate high power laser light.

### BACKGROUND OF THE INVENTION

Continuous wave (CW) lasers with a wavelength range of 550-590 nm have high practical value, such as applications in the field of biomedicine, spectroscopy, data processing, atmospheric detection, and even in remote sensing. Yellow lasers with a wavelength close to 577 nm can be realized in a variety of ways such as semiconductor yellow-orange lasers, second harmonic generating (SHG) for diode lasers, SHGs for fiber lasers and cavity SHG for optically pumped semiconductor lasers and etc.

FIG. 1 shows a conventional laser device 10 for generating laser light with wavelengths in the range of visible lights, in which the pumping light Lₚᵤₘₚ having a wavelength of 808 nanometer (nm) is supplied from the diode laser source 1 at the leftmost in the figure. The linear laser cavity 10 is formed between the first optical component 110 and the second optical component 150. Along the first direction, the linear laser cavity 10 is furnished with a gain medium 120, a Raman medium 130 and a lithium triborate (LBO) crystal 140. The first optical component 110 can be configured to an optical layer having a high transparency (the reflectivity is lower than 0.2%) for the pumping light Lₚᵤₘₚ so as to allow the pumping light Lₚᵤₘₚ incident along the first direction into the cavity 10.

The gain medium 120 receives the pumping light Lₚᵤₘₚ from the first optical component 130, and generates a first infrared base laser light L_{base1} having the first wavelength. For example, the diode laser source 1 provides the incident pumping light Lₚᵤₘₚ with a wavelength of 808 nanometer, and the gain medium 120 contains neodymium-doped vanadate (such as neodymium-doped yttrium vanadate Nd:YVO4), which can absorb the energy of the pumping light Lₚᵤₘₚ and convert it into the first infrared basic laser light L_{base1} with a wavelength of about 1064 nm. When the reflectivity of the first optical component 110 and the second optical component 150 of the linear cavity 10 for the first infrared basic laser light L_{base1} reaches above 99.8%, that is, the first infrared basic laser light L_{base1} can be effectively locked in the first resonant cavity 12 in the linear cavity 10 to form a standing wave, the Raman medium 130 can rely on the excitation of stimulated Raman scattering to generate a second infrared base laser light L_{base2} with a wavelength of about 1159 nm.

The second infrared basic laser light L_{base2} is reflected back and forth in the second resonant cavity 14 in the linear cavity 10. The two basic laser lights existing in the linear cavity 10 can be used as tools to form different visible light wavelengths. The distance between the first optical component 110 and the second optical component 150 allows the two basic laser lights to form a standing wave and maintain a certain power. When the pump light Lₚᵤₘₚ is continuously injected into the linear cavity 10, the energy of the two basic laser lights is continuously increased.

The LBO crystal 140 can be an SHG crystal formed at a special cutting angle, which receives the first and second infrared base laser lights L_{base1}, L_{base2}, and generates visible laser light L₁ with a third wavelength. Taking the embodiment described in the previous paragraph as an example, when the wavelength of the second infrared basic laser light L_{base2} is 1159 nm, the visible laser light L₁ generated due to SHG has a wavelength of about 579.5 nm.

Notably, both the first and second resonant cavities 12,14 employed to maintain the first and second infrared basic laser lights L_{base1}, L_{base2} in the linear cavity 10 are composed of the same optical components. However, when the second infrared basic laser light L_{base2} travels back and forth through the gain medium 120, losses will inevitably occur and its power will be reduced. As a result, the power of the visible laser light L₁ after SHG or sum frequency based on the second infrared basic laser light L_{base2} will be limited. Therefore, how to avoid the shortcomings of the above-mentioned devices is a technical problem that needs to be resolved.

### SUMMARY OF THE INVENTION

To overcome problems in the prior art, the present invention provides a visible laser apparatus with minimized cavity loss for the strokes wave.

According to one aspect of the present invention, there is a visible laser apparatus including a linear cavity having a first direction and a second direction opposite to the first direction. The linear cavity includes along the first direction: a first optical component, a gain medium, a second optical component, a Raman crystal, a double-harmonic crystal and a third optical component. The first optical component receives an incident pumping light in the first direction. The gain medium receives the pumping light from the first optical component, and generates a first infrared base laser having a first wavelength. The second optical component has a first high transmittance in a first wave band including the first wavelength in the first and the second directions. The Raman crystal receives the first infrared base laser, and generates a second infrared base laser having a second wavelength. The double-harmonic crystal receives the first and the second infrared base lasers, and generates a visible laser light having a third wavelength. The third optical component allows the visible laser light to transmit out along the first direction. The first optical component has a first high reflectivity in the first wave band in the second direction. The second optical component has a second high reflectivity in a second wave band including the second wavelength in the second direction. The third optical component has a third high reflectivity in the first and the second wave bands in the first direction and a second high transmittance in a third wave band including the third wavelength in the first direction.

According to another aspect of the present invention, a linear cavity for generating a high power visible laser light is provided. The linear cavity includes along a first direction: a first optical component, a gain medium, a Raman crystal, a lithium triborate (LBO) crystal and a second optical component. The first optical component allows a pumping light incident in the first direction to transmit therethrough. The gain medium receives the pumping light from the first optical component, and generates a first infrared base laser light having a first wavelength. The Raman crystal receives the first infrared base laser light, and generates a second infrared base laser light having a second wavelength. The LBO crystal receives the first and the second infrared base laser lights, and generates a visible laser light having a third wavelength. The second optical component allows the first visible laser light to emit thereout along the first direction, wherein the first optical component has a first reflectivity in a first wave band including the first wavelength in a second direction opposite to the first direction; the Raman crystal include a first surface facing the first direction, and the first surface has a second reflectivity in a second wave band including the second wavelength in the second direction; and the second optical component has a third reflectivity in the first and the second wavebands in the first direction.

According to another aspect of the present invention, linear cavity having a first direction and a second direction opposite to the first direction is provided. The linear cavity includes along the first direction: a first optical component, a gain medium, a second optical component, a Raman crystal and a third optical component. The first optical component allows a pumping light incident in the first direction to transmit therethrough. The gain medium receives the pumping light from the first optical component, and generates a first infrared base laser light having a first wavelength. The second optical component has a first high transmittance in a first wave band including the first wavelength in the first and the second directions. The Raman crystal receives the first infrared base laser, and generates a second infrared base laser having a second wavelength, wherein the first optical component has a first reflectivity in the first waveband in the second direction; the second optical component has a second reflectivity in a second waveband including the second wavelength in the second direction; and the third optical component has a third high reflectivity in the first and the second wave bands in the first direction.

The linear cavity can be employed to provide visible lasers with high out powers, which is useful for medical treatment and industrial needs. Therefore, the present invention has industrial utility.

### BRIEF DESCRIPTION OF THE DRAWINGS

The objectives and advantages of the present invention will become more readily apparent to those ordinarily skilled in the art after reviewing the following detailed descriptions and accompanying drawings.

FIG. 1 is a schematic diagram showing a laser device for generating laser light of visible wavelengths known to the art;

FIG. 2 is a schematic diagram showing a Raman laser for generating high-power laser light with visible wavelengths according to one embodiment of the present invention;

FIG. 3 is a schematic diagram showing a Raman laser for generating high-power laser light with visible wavelengths according to another embodiment of the present invention;

FIG. 4A is a schematic diagram showing the reflectivity for lights of different wavelengths of the first optical component made according to one embodiment of the present invention;

FIG. 4B is a schematic diagram showing the reflectivity for lights of different wavelengths of the second optical component made according to one embodiment of the present invention;

FIG. 4C is a schematic diagram showing the reflectivity for lights of different wavelengths of the third optical component made according to one embodiment of the present invention;

FIG. 4D is a schematic diagram showing the reflectivity for lights of different wavelengths of the fourth optical component made according to one embodiment of the present invention;

FIG. 5 shows a schematic diagram of the laser device made according to the configuration in FIG. 1 in terms of output power;

FIG. 6 shows a schematic diagram of the laser device made according to one embodiment of the present invention in terms of output power.

### DETAILED DESCRIPTION OF THE PREFERRED EMBODIMENTS

The present invention will now be described more specifically with reference to the following embodiments. It is to be noted that the following descriptions of the preferred embodiments of this invention are presented herein for purpose of illustration and description only; they are not intended to be exhaustive or to be limited to the precise form disclosed.

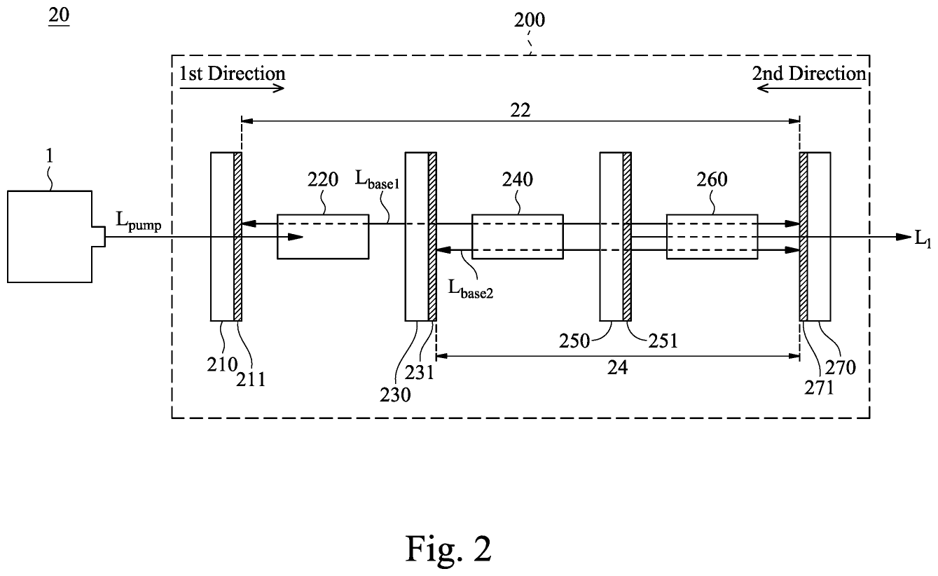

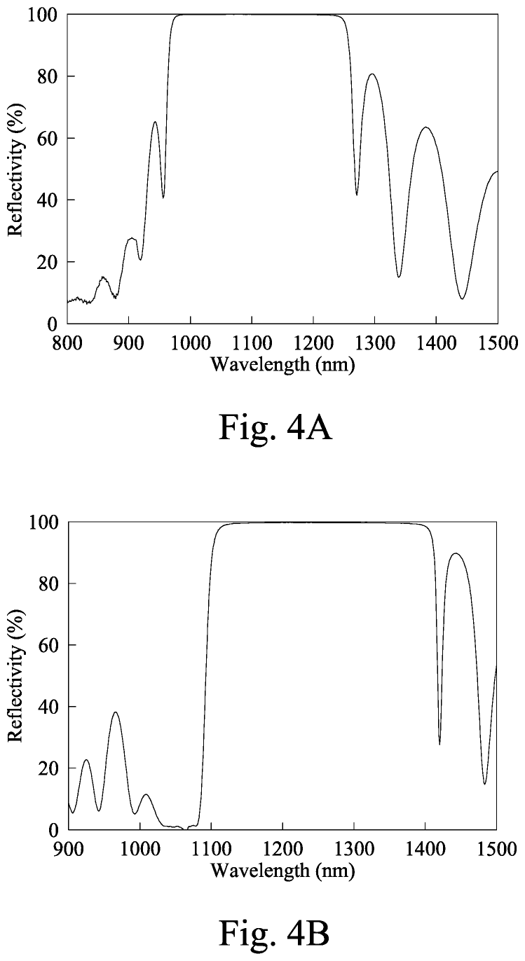

Please refer to FIG. 2, which illustrates a hi-power visible light laser apparatus with a linear cavity according to one embodiment of the present invention. The visible laser 20 includes a linear cavity 200 having the following elements along the first direction: the first optical component 210, the gain medium 220, the second optical component 230, the Raman crystal 240, the third optical component 250, the second harmonic crystal 260 and the fourth optical component 270. FIGS. 4A-4B are schematic diagrams showing the reflectivity for lights of different wavelengths of the optical components 210, 230, 250, 270.

In FIG. 2, the first optical component 210 receives the pumping light Lₚᵤₘₚ with a wavelength of 808 nanometer (nm) supplied by the diode laser source 1 and incident along the first direction. The gain medium 220 includes a neodymium-doped yttrium aluminum garnet (Nd:YAG) crystal, which can convert the pumping light Lₚᵤₘₚ into the first infrared basic laser light L_{base1} with a wavelength of about 1064 nm.

According to an embodiment, the gain medium 220 contains neodymium-doped vanadate (such as neodymium-doped yttrium vanadate Nd:YVO4), which can absorb the energy of the pumping light Lₚᵤₘₚ and converts it into the first infrared basic laser light L_{base1} with a wavelength of about 1064 nm. In the linear cavity 200, when the reflectivity of the first optical component 210 and the fourth optical component 270 for the first infrared basic laser light L_{base1} reaches 99.8% or above, that is, the first infrared basic laser light L_{base1} can be effectively locked in the first resonant cavity 22 to form a standing wave. Notably, the length of the gain medium 220 provided by the present invention is controlled under a certain range to avoid the phenomena of self-stimulated Raman scattering, and thus will generate the first infrared basic laser light L_{base1} with the mentioned wavelength only.

According to FIG. 4B, the second optical component 230 has a high transparency, such as 99.8% or more, for the light with a wavelength about 1164 nm so as to allow the first infrared basic laser light L_{base1} to pass therethrough. In one embodiment, the present invention employs a crystal made of potassium gadolinium tungstate (KGW) as the Raman crystal 240. After the first infrared basic laser light Lbase1 is incident thereinto, the Raman crystal 240 can generate the second infrared base laser L_{base2} with a wavelength of 1159 nm via stimulated Raman scattering. The two basic laser lights existing in the linear cavity 200 can be used as tools for forming laser lights with different visible light wavelengths.

As shown in FIG. 4C, according to an embodiment, the third optical component 250 has a low reflectivity for light with a wavelength at above 1000 nm, so that the first infrared basic laser light Lbase1 and the second infrared basic laser light Lbase2 can pass with ease. The second harmonic crystal 260 is a lithium triborate (LBO) crystal. When the wavelength of the second infrared base laser light Lbase2 is about 1159 nm, the visible laser light L1 generated after the frequency doubling has a wavelength of about 579.5 nm. The third optical component 250 has high reflectivity (for example, above 98%) in a visible light range of 550-600 nm, so it can prevent the visible laser light L1 from being incident from the second direction and causing a loss.

Under appropriate device arrangement, the first and the second infrared basic laser light L_{base1}, L_{base2} can be reflected back and forth in the linear cavity 200. As shown in FIGS. 4A, 4B, and 4D, the first optical component 210 has a high reflectivity of 99.9% for lights with wavelengths in the wavelength range (for example, 1000-1180 nm) covering that of the first infrared basic laser light L_{base1}, the reflectivity of the second optical component 230 for lights with wavelength in the wavelength range of the second infrared base laser light L_{base2} (for example, 1060-1180 nm) reaches 99.9%, and the fourth optical element 270 has a high reflectivity of 99.95% for the wavelength range covering the wavelengths of the first and second infrared base laser light L_{base1}, L_{base2} (for example, 920-1160 nm). Therefore, the first resonant cavity 22 composed of the first optical component 210 and the fourth optical component 270 makes the first infrared basic laser light L_{base1} form a standing wave and maintain a certain power. The second resonant cavity 24 composed of the second optical component 230 and the fourth optical component 270 makes the second infrared basic laser light L_{base2} form a standing wave and maintain a certain power. When the pumping light Lₚᵤₘₚ is continuously injected into the gain medium 220, the power of the infrared basic laser lights L_{base1}, L_{base2} in the linear cavity 200 will be continuously escalated.

Since the range of the second resonant cavity 24 does not overlap with the optical path between the first optical component 210 and the second optical component 230, the second infrared basic laser light L_{base2} will not enter the gain medium 220 after it is formed and cause a chance of power loss, therefore the linear cavity 200 of the present invention can fully utilize the energy of the second infrared basic laser light L_{base2}, and the power of the visible laser light L₁ originated from the second infrared basic laser light L_{base2} can be increased.

The functional features of the various optical components in FIG. 2, such as the first optical component 210, the second optical component 230, the third optical component 250 and the fourth optical component 270, are mainly realized by optical films in practice. This is implemented on the surface of a transparent element. For example, the first optical component 210 has an optical film 211, the second optical component 230 has an optical film 231, the third optical component 250 has an optical film 251, and the fourth optical component 270 has an optical film 271. Each optical component can be kept at a distance from the other as shown in the figure, or any of the gaps can be removed and the optical component is directly attached to the surface of the adjacent crystal or dielectric element, which does not exceed the scope of the present invention.

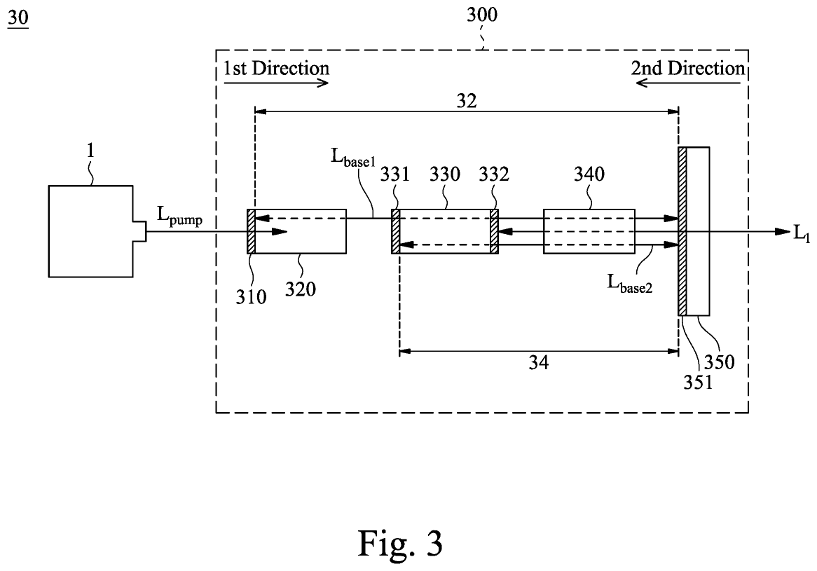

Please refer to FIG. 3, which illustrates a hi-power visible light laser apparatus with a linear cavity according to another embodiment of the present invention. The visible laser 30 includes a linear cavity 300 having the following elements along the first direction: the first optical component 310, the gain medium 320, the Raman crystal 330, the LBO crystal 340 and the second optical component 350. The Raman crystal 330 has a first surface 331 facing the first direction and a second surface 332 opposite to the first surface 331. That is, the second surface 332 faces the second direction. In order to realize the required optical characteristics, the first and the second surfaces 331, 332 of the Raman crystal 330 can be formed by plating or film-sticking methods.

The optical characteristics of the first optical component 310, the first surface 331, the second surface 332 and the second optical component 350 in FIG. 3 are respectively the same as those of the optical components 210, 230, 250, 270 in FIG. 2, and the reflectivity of each for lights of different wavelengths are the same as those in FIG. 4A-4D.

As shown in FIG. 3, the first optical component 310 receives the pumping light Lₚᵤₘₚ provided by the diode laser source 1 and incident along the first direction with a wavelength of 808 nm.

The gain medium 320 is the same as the gain medium 220 shown in FIG. 2, which can convert the pumping light Lₚᵤₘₚ with a wavelength of 808 nanometers into the first infrared base laser light L_{base1} with a wavelength of about 1064 nm. When the reflectivity of the first optical component 310 and the second optical component 350 of the linear cavity 300 for the first infrared basic laser light L_{base1} reaches more than 99.8%, the first infrared basic laser light L_{base1} can be effectively locked in the first resonant cavity 32 to form a standing wave.

The function of the first surface 331 is equivalent to that of the second optical component 230 in FIG. 2, which has a high transparency (for example, 99.8% or above) for light having a wavelength of about 1064 nm, so as to allow the infrared basic laser light L_{base1} to pass therethrough. When the first infrared basic laser light L_{base1} is incident therein, the Raman crystal 330 can generate the second infrared basic laser light L_{base2} with a wavelength of about 1159 via stimulated Raman scattering. The function of the second surface 332 is equivalent to that of the third optical element 250 in FIG. 2, which has a low reflectivity for light having a wavelength exceeding 1000 nm, so that the first infrared basic laser light L_{base1} and the second infrared basic laser light L_{base2} can pass therethrough with ease. The two basic laser lights existing in the linear cavity 300 can be used as tools for forming laser lights with different visible light wavelengths.

Under appropriate device arrangement, the first and the second infrared basic laser light L_{base1}, L_{base2} can be reflected back and forth in the linear cavity 300. As shown in FIGS. 4A, 4B, and 4D, the first optical component 310 has a high reflectivity of 99.9% for lights with wavelength in the wavelength range (for example, 1000-1180 nm) covering that of the first infrared basic laser light L_{base1}, the reflectivity of the first surface 331 for lights with wavelength in the wavelength range covering that of the second infrared base laser light L_{base2} (for example, 1059-1300 nm) reaches 99.9%, and the function of the second optical component 350 is the same as that of the fourth optical component 270 in FIG. 2 which has a high reflectivity of 99.95% for lights with wavelengths in the wavelength range covering the wavelengths of the first and second infrared base laser light L_{base1}, L_{base2} (for example, 920-1160 nm). Therefore, the first resonant cavity 32 composed of the first optical component 310 and the second optical component 350 makes the first infrared basic laser light L_{base1} form a standing wave and maintain a certain power. The second resonant cavity 34 composed of the first surface 331 and the second optical component 350 makes the second infrared basic laser light L_{base2} form a standing wave and maintain a certain power. When the pumping light Lₚᵤₘₚ is continuously injected into the gain medium 320, the power of the infrared basic laser lights L_{base1}, L_{base2} in the linear cavity 300 will be continuously escalated.

In this embodiment, since the range of the second resonant cavity 34 does not overlap with the optical path between the first optical component 310 and the first surface 331, the second infrared basic laser light L_{base2} will not enter the gain medium 320 after it is formed and cause a chance of power loss, therefore the linear cavity 300 of the present invention can fully utilize the energy of the second infrared basic laser light L_{base2}, and the power of the visible laser light L₁ originated from the second infrared basic laser light L_{base2} can be increased.

The LBO crystal 340 receives the first and the second infrared basic laser lights L_{base1}, L_{base2}, and generates visible laser light L₁ with the third wave length such as 579.5 nm, 556 nm or 532 nm. The LBO crystal 340 can be formed of an SHG crystal or a sum frequency generation crystal, depending on different cutting angle. When the LBO crystal 340 is configured as an SHG crystal, it can generate a wavelength of 579.5 nm (the second infrared base laser light L_{base2} with a wavelength of about 1159 nm) or 532 nm (the first infrared laser light L_{base1} with a wavelength of about 1064). When the LBO crystal 340 is used as a frequency doubling crystal, it can generate a visible laser light L₁ with a wavelength of 556 nm (the first infrared basic laser light L_{base1} with a wavelength of about 1064 and the second infrared basic laser light L_{base2} with a wavelength of about 1159).

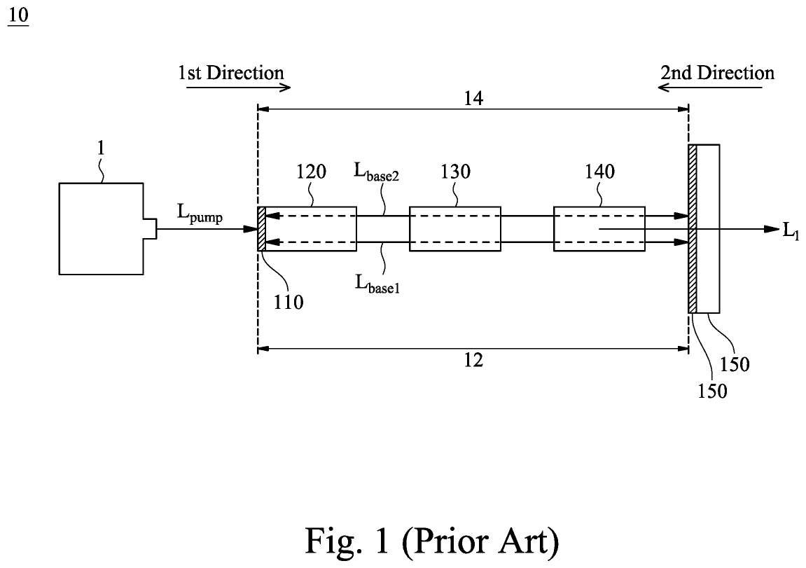

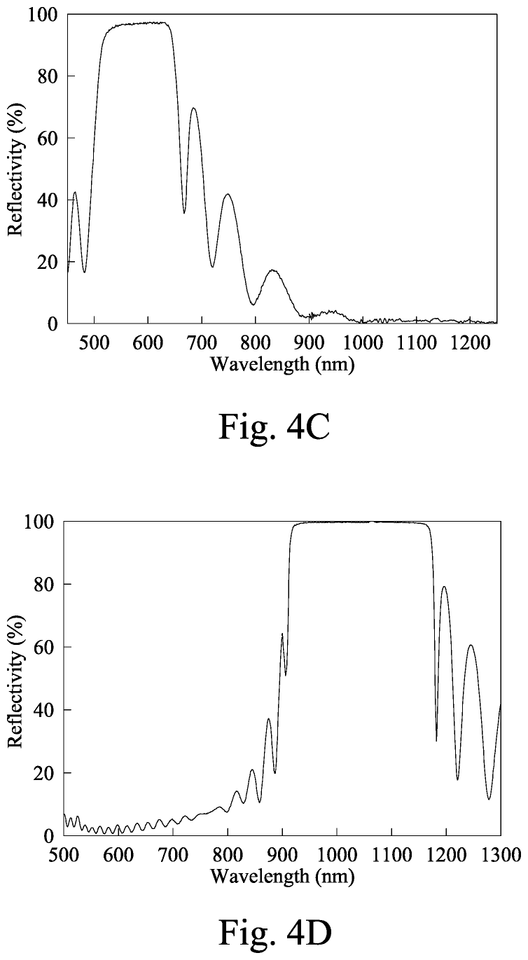

Refer to FIG. 5, which shows the data obtained by experiments with projecting pumping light of different powers according to the configuration of the laser device 10 illustrated in FIG. 1. It can be seen from the figure that when the incident pumping light reaches 30 watts, the power of the generated infrared basic laser with a wavelength of about 1159 is less than 2 watts, while the visible light laser with a wavelength of 579.5 nm is less than 4 watts.

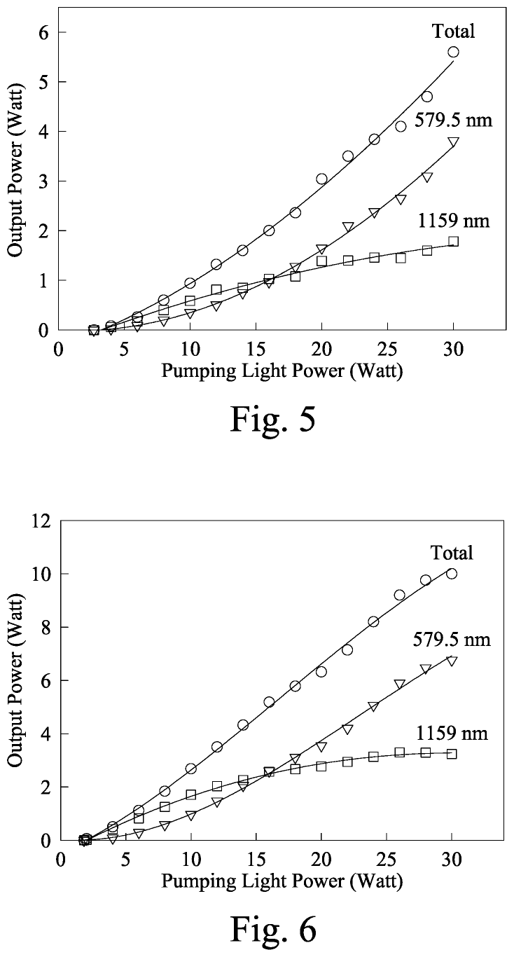

Refer to FIG. 6, which shows data obtained by experiments with a laser device made according to an embodiment of the present invention and projecting pumping light of different powers. It can be seen from the figure that when the incident pumping light reaches 30 watts, the power of the generated infrared basic laser light with a wavelength of about 1159 exceeds 3 watts, and the visible laser light with a wavelength of 579.5 nanometers exceeds 6 watts.

Comparing the data in FIGS. 5 and 6, it can be seen that the linear cavity configuration proposed by the present invention significantly increases the power of infrared basic laser light with a wavelength of about 1159 nm, and further significantly increases the power of the visible laser light with a wavelength of 579.5 nm. The power of visible laser light can be a major innovation and breakthrough in the technology field.

While the invention has been described in terms of what is presently considered to be the most practical and preferred Embodiments, it is to be understood that the invention need not be limited to the disclosed Embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A visible laser apparatus including a linear cavity having a first direction and a second direction opposite to the first direction, the linear cavity comprising along the first direction:
a first optical component receiving an incident pumping light in the first direction;
a gain medium receiving the pumping light from the first optical component, and generating a first infrared base laser having a first wavelength;
a second optical component having a first high transmittance in a first wave band including the first wavelength in the first and the second directions;
a Raman crystal receiving the first infrared base laser, and generating a second infrared base laser having a second wavelength;
a double-harmonic crystal receiving the first and the second infrared base lasers, and generating a visible laser light having a third wavelength; and
a third optical component allowing the visible laser light to transmit out along the first direction, wherein:
the first optical component has a first high reflectivity in the first wave band in the second direction;
the second optical component has a second high reflectivity in a second wave band including the second wavelength in the second direction; and
the third optical component has a third high reflectivity in the first and the second wave bands in the first direction and a second high transmittance in a third wave band including the third wavelength in the first direction.

2. The visible laser apparatus according to claim 1, wherein the linear cavity further comprises a fourth optical element disposed between the Raman crystal and the double-harmonic crystal, and having a fourth high reflectivity in the third wave band in the second direction.

3. The visible laser apparatus according to claim 1, wherein the gain medium includes a neodymium doped vanadate, and the Raman crystal includes a KGW material.

4. The visible laser apparatus according to claim 1, wherein the double-harmonic crystal includes a lithium triborate (LBO) crystal.

5. The visible laser apparatus according to claim 1, wherein the first and the third optical components constitute a first cavity.

6. The visible laser apparatus according to claim 5, wherein the first cavity is configured to maintain a first standing wave status for the first infrared base laser.

7. The visible laser apparatus according to claim 1, wherein the second and the third optical components constitute a second cavity.

6. The visible laser apparatus according to claim 7, wherein the second cavity is configured to maintain a second standing wave status for the first infrared base laser.

9. A linear cavity for generating a high power visible laser light, comprising along a first direction:
a first optical component allowing a pumping light incident in the first direction to transmit therethrough;
a gain medium receiving the pumping light from the first optical component, and generating a first infrared base laser light having a first wavelength;
a Raman crystal receiving the first infrared base laser light, and generating a second infrared base laser light having a second wavelength;
a lithium triborate (LBO) crystal receiving the first and the second infrared base laser lights and generating a visible laser light having a third wavelength; and
a second optical component allowing the first visible laser light to emit thereout along the first direction, wherein:
the first optical component has a first reflectivity in a first wave band including the first wavelength in a second direction opposite to the first direction;
the Raman crystal include a first surface facing the first direction, and the first surface has a second reflectivity in a second wave band including the second wavelength in the second direction; and
the second optical component has a third reflectivity in the first and the second wavebands in the first direction.

10. The linear cavity according to claim 9, wherein the Raman crystal includes a second surface facing the second direction.

11. The linear cavity according to claim 10, wherein the second surface has a fourth high reflectivity in a third wave band including the third wavelength in the second direction.

12. The linear cavity according to claim 9, wherein the gain medium includes a neodymium doped vanadate.

13. The linear cavity according to claim 9, wherein the Raman crystal includes a KGW material.

14. The linear cavity according to claim 9, wherein the LBO crystal is employed as a double-harmonic crystal.

15. The linear cavity according to claim 9, wherein the LBO crystal is employed as a sum frequency generation crystal.

16. The linear cavity according to claim 9, wherein the first and the second optical components constitutes a first cavity configured to maintain a first standing wave status for the first infrared base laser.

17. The linear cavity according to claim 9, wherein the first surface and the second optical components constitute a second cavity configured to maintain a second standing wave status for the second infrared base laser.

18. A linear cavity having a first direction and a second direction opposite to the first direction, the linear cavity comprising along the first direction:
a first optical component allowing a pumping light incident in the first direction to transmit therethrough;
a gain medium receiving the pumping light from the first optical component, and generating a first infrared base laser light having a first wavelength;
a second optical component having a first high transmittance in a first wave band including the first wavelength in the first and the second directions;
a Raman crystal receiving the first infrared base laser, and generating a second infrared base laser having a second wavelength; and
a third optical component, wherein:
the first optical component has a first reflectivity in the first waveband in the second direction;
the second optical component has a second reflectivity in a second waveband including the second wavelength in the second direction; and
the third optical component has a third high reflectivity in the first and the second wave bands in the first direction.

19. The linear cavity according to claim 18, further comprising a lithium triborate (LBO) crystal disposed between the Raman crystal and the third optical component, receiving the first and the second infrared base laser lights, and generating a visible laser light having a third wavelength.

20. The linear cavity according to claim 18, further comprising a fourth optical component disposing between the Raman crystal and the LBO crystal, and having a fourth high reflectivity in a third waveband including the third wavelength.
